(19) United States
(12) Patent Application Publication
(10) Pub. No.: US 2021/0337244 A1
(43) Pub. Date: Oct. 28, 2021

(54) MOBILE PHYSICAL HARM DETERRENT SYSTEM

(71) Applicant: WalkSafer LLC, Flowery Branch, CA (US)

(72) Inventors: Arthur Michael McCracken, Atlanta, GA (US); Julie Lockwood McCracken, Atlanta, GA (US); Jonathan Blake McCracken, Woodstock, GA (US)

(21) Appl. No.: 17/236,396

(22) Filed: Apr. 21, 2021

Related U.S. Application Data
(60) Provisional application No. 63/013,810, filed on Apr. 22, 2020.

(51) Int. Cl. H04N 21/2187; H04N 21/234; H04N 21/414; H04M 1/72424; G08B 3/10; G08B 5/38

(52) U.S. Cl. CPC H04N 21/2187; H04N 21/234; G08B 5/38; H04M 1/72424; G08B 3/10; H04N 21/41407

(57) ABSTRACT

Methods, systems, and computer-readable storage media for providing a physical harm deterrent system. Upon receiving an initiation of a physical harm deterrent application by a user of a handheld video streaming device, a video camera of the handheld video streaming device is activated by the physical harm deterrent application. In conjunction with the activation of the video camera, a lighted alert feature of the handheld video streaming device is also activated, the lighted alert feature configured to indicate to persons approaching the user of the handheld video streaming device the physical harm deterrent application is active. The physical harm deterrent application streams live video from the video camera to a remote storage location.

### CROSS-REFERENCE TO RELATED APPLICATIONS

This application claims the benefit of U.S. Provisional Application No. 63/013,810 filed Apr. 22, 2020, entitled “Mobile Physical Harm Deterrent System,” the entire disclosure of which is hereby incorporated herein by this reference.

### BRIEF SUMMARY

The present disclosure relates to technologies for a physical harm deterrent system comprising a handheld video streaming device, a lighted alert feature, remote video streaming servers, and associated hardware and software. According to some embodiments, a method comprises receiving an initiation of a physical harm deterrent application by a user of the handheld video streaming device. In response to receiving the initiation, a video camera of the handheld video streaming device is activated by the physical harm deterrent application. In conjunction with the activation of the video camera, a lighted alert feature of the handheld video streaming device is also activated, the lighted alert feature configured to indicate to persons approaching the user of the handheld video streaming device the physical harm deterrent application is active. Finally, live video is streamed from the video camera to a remote storage location.

According to further embodiments, a computer-readable medium comprises processor-executable instructions that cause a processor of a handheld video streaming device to, in response to receiving an initiation of a physical harm deterrent application by a user of the device, activate a video camera of the device. In conjunction with the activation of the video camera, a lighted alert feature of the handheld video streaming device is also activated, the lighted alert feature configured to indicate to persons approaching the user of the handheld video streaming device that the physical harm deterrent application is active. Live video from the video camera is streamed by the processor to a remote storage location.

According to further embodiments, a physical harm deterrent system comprises an app for execution on a smartphone and at least one remote video streaming server located at a remote storage location. The app is configured to, upon initiation by a user of the smartphone, activate a video camera of the smartphone and stream live video from the video camera to the remote storage location. The smartphone comprises a lighted alert feature configured to be activated in conjunction with the activation of the video camera by the app. For example, lighted alert feature may be embedded in a cellphone case encasing the smartphone or a light on the smartphone device itself. The at least one remote video streaming server is configured to receive the streamed video from the smartphone and store the received video in video storage at the remote storage location.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a system diagram showing the components of the WalkSafer system, according to embodiments presented herein.

FIG. 2 is a GUI diagram showing the display of a smartphone or handheld video streaming device with a smart button link that launches the WalkSafer app, according to embodiments presented herein.

FIG. 3 is a plan view of a rear surface of a smartphone and/or a case for a mobile device or smartphone including a lighted indicator that indicates to a potential assailant that video streaming is engaged on the mobile device, according to embodiments presented herein.

FIG. 4 are flow charts showing routines for providing a physical harm deterrent system, according to embodiments presented herein.

FIG. 5 is a block diagram showing an example computer architecture for computer(s) capable of executing the software components described herein, according to embodiments described herein.

### DETAILED DESCRIPTION

The following detailed description is directed to technologies for a physical harm deterrent system comprising a handheld video streaming device, a lighted alert feature, one or more remote video streaming servers, and associated hardware and software. Physical assaults and other physical criminal acts represent an ever-increasing risk to individuals. In order to better protect themselves from such risks, people may use any number of conventional deterrent and protection devices, including mace, whistles, personal alarm units, guns, knives, assorted clubs/metal knuckles, and the like. In addition, many people take self-defense classes and learn physical protection techniques that, for the most part, require physical interaction with an assailant in order to escape to safety. While these traditional solutions are beneficial to the safety of one's physical being, there is a need for additional safety measures that deter potential assailants before a physical confrontation begins.

In today's technology environment, a massive percentage of active children, teens and adults carry mobile smartphones that are equipped with video cameras. Utilizing the technologies disclose herein, a physical harm deterrent system, referred to collectively as the “WalkSafer system,” may be implemented that leverages these video camera-equipped smartphones to allow a person to better protect themselves by making themselves a less likely target of aggressive acts. There are various studies and surveys available on the web that conclude that when perpetrators believe they may be on camera, they are far less likely to approach a target which may include a facility or a person. But simply equipping persons with a smart phone and video camera is not sufficient, since an assailant could simply take and destroy the phone/camera as part of the attack. Accordingly, the presence of a video camera by itself is not sufficient to deter an attacker. However, if the video camera can be made to stream live video to a remote location at the time an assailant is considering a potential aggression, and the assailant can be made aware that any attack would likely be captured in the streamed video if they were to attempt such, then such an innovation would deter the assailant before the attack takes place.

The WalkSafer system utilizes a handheld video streaming device in a person's possession, e.g., a smartphone with embedded video camera, that streams video to a remote storage location during the times when that person may be more susceptible to an attack. Potential assailants are alerted to the fact that the person is utilizing the WalkSafer system and is or may be actively streaming video by way of a lighted alert feature of the mobile device, e.g. a light or lit emblem embedded in a cellphone case or implemented in the mobile device itself, and/or an audio alert feature of the device, e.g., a speaker of the smartphone, that indicates the smartphone is so equipped. As knowledge of the WalkSafer system becomes widespread, even if the streaming video feature is not engaged, so long as the lighted alert feature and/or audio alert feature are in use, potential assailants may be deterred. Therefore, the WalkSafer system creates a safer environment for a person carrying a video streaming equipped device.

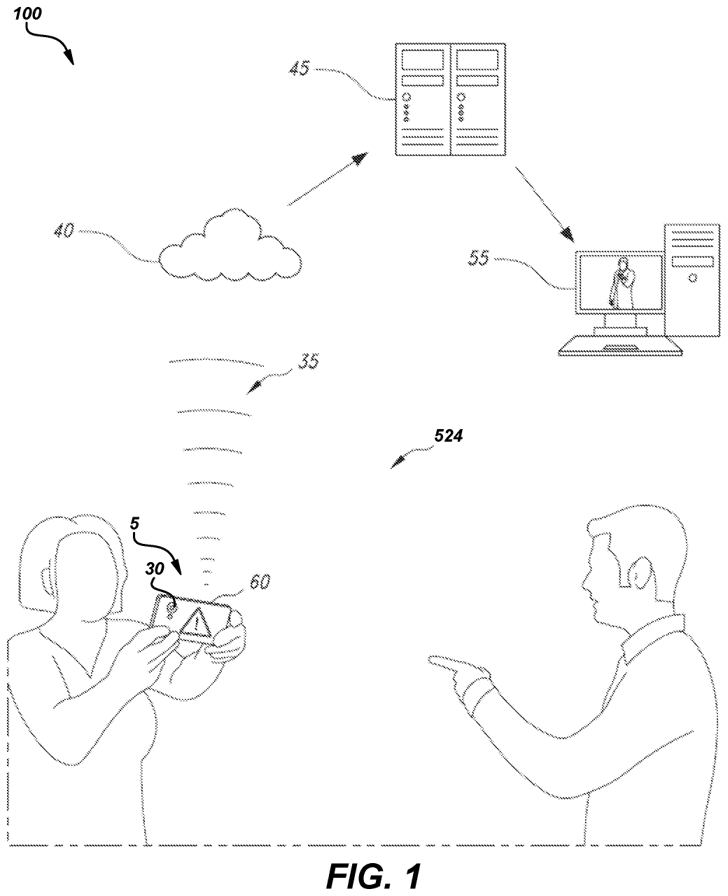

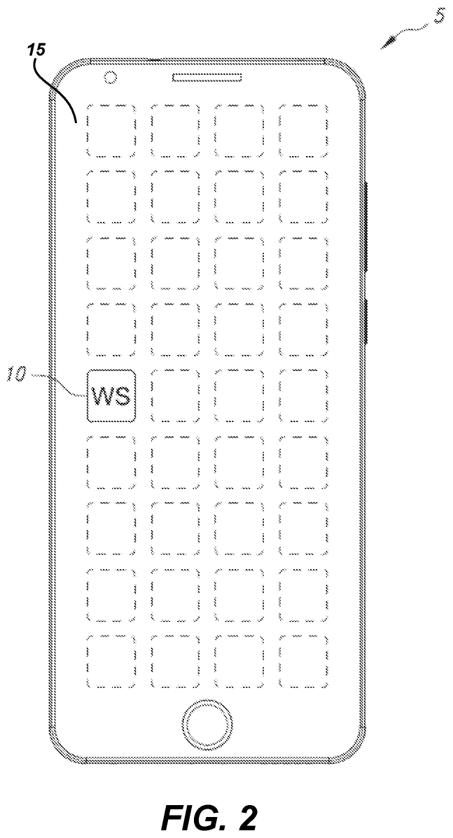

FIG. 1 shows an overview of the WalkSafer system 100, according to some embodiments. The WalkSafer system 100 comprises a software application 524, referred to herein as the “WalkSafer app,” that executes on a smartphone 5 or other handheld video streaming device. The WalkSafer app 524 may be initiated on the smartphone 5 by the user by selecting an icon 10 associate with the app on a touchscreen display 15 on the front surface of the device, for example, as shown in FIG. 2. The user of the smartphone 5 may initiate the WalkSafer app 524 when the user anticipates that they may be venturing into an uncomfortable situation, location, or circumstance where they may be at risk.

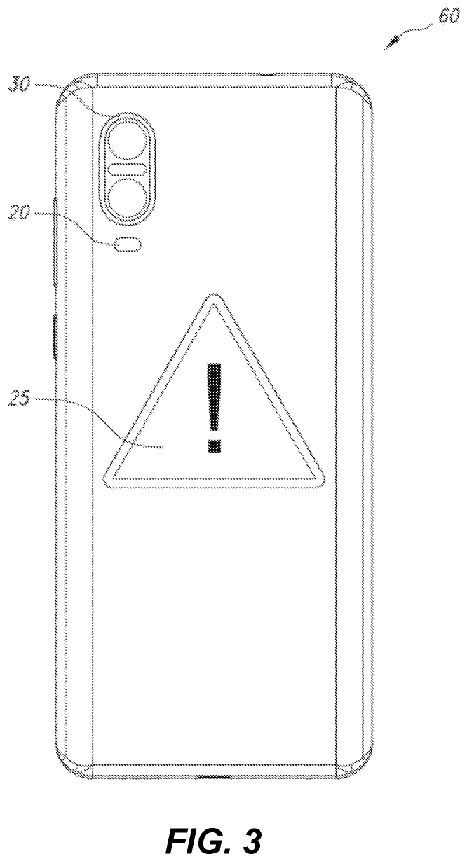

Returning to FIG. 1, once initiated by the user, the WalkSafer app 524 may digitally stream live video from a video camera 30 of the smartphone 5 to a remote storage location. For example, the WalkSafer app 524 may stream video from the embedded video camera 30 located on the back surface of the smartphone 5, as shown in FIGS. 1 and 3. The mobile device 5 may be linked to the remote storage location via a wireless link 35 through the Internet or “cloud” and/or other networks 40. The streamed video is collected by remote video streaming server(s) 45 at the remote storage location and the video stream is associated with the specific remitting device. Simultaneous data collection at the smartphone and at the remote location eliminates the motivation of the assailant to destroy or discard the smartphone 5 in an attempt to eliminate any incriminating video evidence. The video stream is catalogued on the remote video streaming server(s) 45 and can be made available for later viewing on the smartphone 5 or other computing devices 55 authorized by the smartphone user.

According to further embodiments, the WalkSafer system 100 also includes the lighted alert feature indicating that the person is utilizing the WalkSafer app 524, thus putting potential assailants on alert that any attacks will be captured through video streaming and stored remotely. In some embodiments, the lighted alert feature may comprise an integrated light or flasher 20, a visual lit-up emblem 25, and/or the like that is activated with the WalkSafer app 524 in such a way to clearly evidence to anyone approaching the smartphone user the device is videotaping their path of movement and that anyone who approaches them will be caught on videotape. For example, as shown in FIG. 3 the light/flasher 20 or visual lit-up emblem 25 may be implemented in a cellphone case 60 encasing the smartphone 5. In further embodiments, the lighted alert feature may utilize a light or lighted emblem that is part of the smartphone 5, such as one associated with the embedded video camera 30. In yet further embodiments, the WalkSafer system 100 may further include an audio alert feature that is activated with the WalkSafer app 524. For example, the WalkSafer app 524 may play an alert tone through a phone sound alarm system embedded in the smartphone 5.

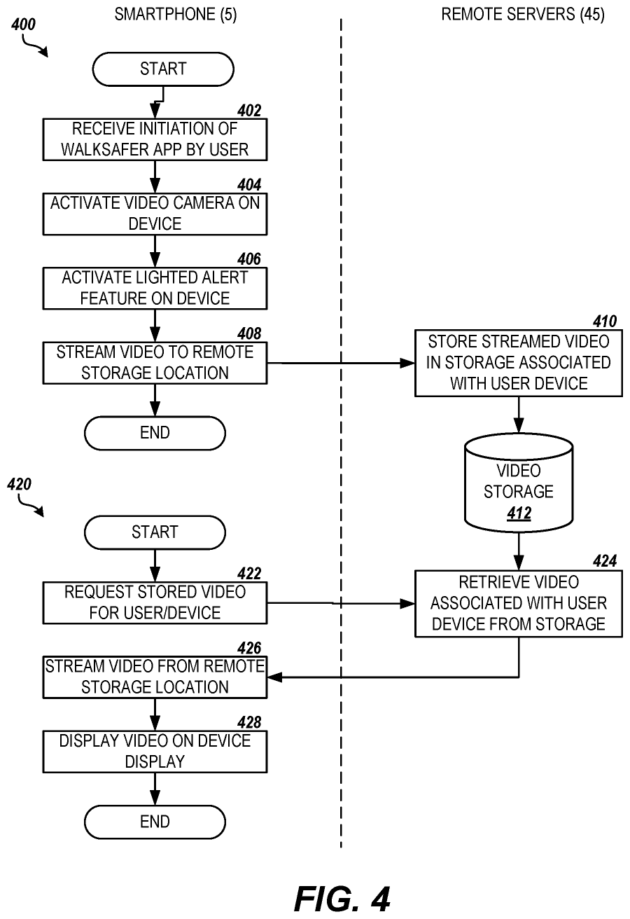

FIG. 4 illustrates one routine 400 for utilizing the WalkSafer system 100 to deter physical harm of a user of the system, according to some embodiments. In some embodiments, parts of the routine 400 may be performed by the WalkSafer app 524 executing on the smartphone 5 in conjunction with remote video streaming server(s) 45 at the remote storage location connected to the smartphone over one or more networks 40. In other embodiments, the routine 400 may be performed by some combination of the smartphone 5 or other handheld video streaming device, the remote video streaming server(s) 45, and other computing devices, components, and modules of the WalkSafer system 100.

The routine 400 begins at step 402, where the WalkSafer app 524 is initiated by the user of the smartphone 5. For example, by the WalkSafer app 524 may be initiated by the user by selecting an icon 10 associate with the app on a touchscreen display 15 of the device when the user anticipates that they may be venturing into an uncomfortable situation, location, or circumstance where they may be at risk. Once the WalkSafer app 524 is initiated by the user, the routine 400 proceeds from step 402 to step 404, where the app activates the embedded video camera 30 on the smartphone 5 in order to capture video from the device for streaming to the remote video streaming server(s) 45.

Next, at step 406, the lighted alert feature and/or the audio alert feature of the WalkSafer system 100 are activated in conjunction with the activation of the video camera 30 by the WalkSafer app 524 to put potential assailants on alert that any attacks will be captured through video streaming and stored remotely. For example, the light/flasher 20, visual lit-up emblem 25, and/or other lighted alerts of the smartphone 5 and/or cellphone case 60 may be turned on in conjunction with activation of the video camera 30. In addition, the WalkSafer app 524 may play an alert tone through a phone sound alarm system embedded in the smartphone 5.

From step 406, the routine 400 proceeds to step 408, where the WalkSafer app 524 streams live video from the embedded video camera 30 of the smartphone 5 to the remote video streaming server(s) 45 of the remote storage location over the network(s) 40. The remote video streaming server(s) 45 may then store the streamed video associated with the user or user device to non-volatile video storage 412 for future retrieval, as shown at step 410. The, the WalkSafer app 524 may continue to stream live video from the video camera 30 to the remote video streaming server(s) 45 at step 408 until the user terminates the app, for example. Once the WalkSafer app 524 is terminated, the routine 400 ends.

FIG. 4 further illustrates one routine 420 for retrieving stored video from the WalkSafer system 100 by a user of the system, according to some embodiments. For example, the user of the smartphone 5 or others authorized by the user, such as law enforcement, may utilize the routine 420 to review stored video from the smartphone 5 in conjunction with an investigation of an associated attack. In some embodiments, parts of the routine 420 may be performed by a website hosted on the remote video streaming server(s) 45 at the remote storage location accessed by the WalkSafer app 524 or a web browser executing on the smartphone 5 or another computing device 55 of the user. In other embodiments, the routine 400 may be performed by some combination of the smartphone 5, the computing device 55, the remote video streaming server(s) 45, and/or other computing devices, components, and modules of the WalkSafer system 100.

The routine 420 begins at step 422, where the smartphone 5 or computing device 55 sends a request to the remote video streaming server(s) 45 to retrieve video associated with the user or user device. The remote video streaming server(s) 45 may then retrieve the requested stored video from the video storage 412 and make it available for steaming to the smartphone 5 or computing device 55, as shown at step 424. The routine 420 proceeds from step 424 to step 426, where the smartphone 5 or computing device 55 streams the requested video from the remote storage location retrieved by the remote video streaming server(s) 45 and displays it on a display of the device, such as the smartphone's touchscreen display 15, as shown at step 428. Once the entire video has been streamed, or the process has been terminated by the user, the routine 420 ends.

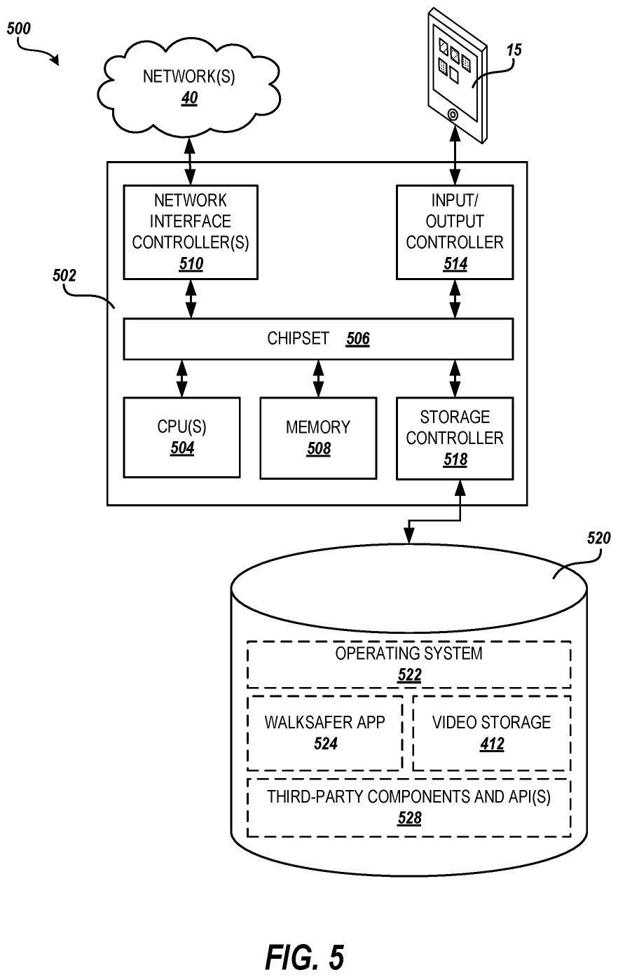

FIG. 5 shows an example computer architecture 500 for a computing device 502 capable of executing software components described herein for optimizing rendering performance of web pages containing one or more advertisements. The computer architecture 500 shown in FIG. 5 illustrates a mobile device, server, desktop computer, laptop, workstation, or other computing device, and may be utilized to execute any aspects of the software components presented herein described as executing on the smartphone 5 or handheld video streaming device, the computing device 55, the remote video streaming server(s) 45, or other computing platform. The computer 502 may include a baseboard, or “motherboard,” which is a printed circuit board to which a multitude of components or devices may be connected by way of a system bus or other electrical communication paths.

In some embodiments, one or more central processing units (“CPUs”) 504 operate in conjunction with a chipset 506. The CPU(s) 504 may be standard programmable processors that perform arithmetic and logical operations necessary for the operation of the computer 502. The chipset 506 provides an interface between the CPU(s) 504 and the remainder of the components and devices on the baseboard. The chipset 506 may provide an interface to a memory 508. The memory 508 may include a random access memory (“RAM”) used as the main memory in the computer 502. The memory 508 may further include a computer-readable storage medium such as a read-only memory (“ROM”) or non-volatile RAM (“NVRAM”) for storing basic routines that that help to startup the computer 502 and to transfer information between the various components and devices. The ROM or NVRAM may also store other software components necessary for the operation of the computer 502 in accordance with the embodiments described herein.

According to various embodiments, the computer 502 may operate in a networked environment using logical connections to remote computing devices through one or more networks, such as a Wi-Fi network, a LAN, a WAN, a cellular data network, the Internet or “cloud,” or any other networking topology known in the art that connects the computer 502 to other, remote computers or computing systems, including the network(s) 40 described herein in regard to FIG. 1. The chipset 506 may include functionality for providing network connectivity through one or more network interface controllers (“NICs”) 510, such as a gigabit Ethernet adapter, a Wi-Fi adapter, or an LTE data adapter. It should be appreciated that any number of NIC(s) 510 may be present in the computer 502, connecting the computer to other types of networks and remote computer systems beyond those described herein.

The computer 502 may also include an input/output controller 514 for interfacing with various external devices and components, such as a touchscreen display 15 of a smartphone 5, for example. Other examples of external devices that may be interfaced to the computer 502 by the input/output controller 514 include, but are not limited to, standard user interface components of a keyboard, mouse, and display, a touchpad, an electronic stylus, a computer monitor or other display, a video camera, a printer, an external storage device, such as a Flash drive, and the like. According to some embodiments, the input/output controller 514 may include a USB controller.

The computer 502 may be connected to one or more mass storage devices 520 that provide non-volatile storage for the computer. Examples of mass storage devices 520 include, but are not limited to, hard disk drives, solid-state (Flash) drives, optical disk drives, magneto-optical disc drives, magnetic tape drives, memory cards, holographic memory, or any other computer-readable media known in the art that provides non-transitory storage of digital data and software. The mass storage device(s) 520 may be connected to the computer 502 through a storage controller 518 connected to the chipset 506. The storage controller 518 may interface with the mass storage devices 520 through a serial attached SCSI (“SAS”) interface, a serial advanced technology attachment (“SATA”) interface, a fiber channel (“FC”) interface, or other standard interface for physically connecting and transferring data between computers and physical storage devices.

The mass storage device(s) 520 may store system programs, application programs, other program modules, and data, which are described in greater detail in the embodiments herein. According to some embodiments, the mass storage device(s) 520 may store an operating system 522 utilized to control the operation of the computer 502. In some embodiments, the operating system 522 may comprise the IOS® or ANDROID™ mobile device operating systems from Apple, Inc. and Google, LLC, respectively. In further embodiments, the operating system 522 may comprise the WINDOWS® operating system from MICROSOFT Corporation of Redmond, Wash. In yet further embodiments, the operating system 522 may comprise the LINUX operating system, the WINDOWS® SERVER operating system, the UNIX operating system, or the like. The mass storage device(s) 520 may store other system or application program module and data described herein, such as the WalkSafer app 524, the video storage 412, or the third-party components and APIs 528 utilized by the WalkSafer system 100 and described in the various embodiments. In some embodiments, the mass storage device(s) 520 may be encoded with computer-executable instructions that, when executed by the computer 502, perform the routines 400 and 420 described in regard to FIG. 4 for providing a physical harm deterrent system.

It will be appreciated that the computer architecture 500 may not include all of the components shown in FIG. 5, may include other components that are not explicitly shown in FIG. 5, or may utilize an architecture completely different than that shown in FIG. 5. For example, the CPU(s) 504, memory 508 and mass storage devices 520, and NIC(s) 510 of the computer architecture 500 may represent components of a System-on-a-Chip (“SoC”) integrated circuit utilized in a handheld video streaming device or smartphone, virtualized resources from any number of server computers or computing devices, or generic processing resources, storage resources, and communication resources of a cloud-based computing system, with the chipset 506 representing communication interlinks between the processing, storage, communication, and other computing resources in the cloud-based computing system. It is intended that all such computing architectures be included within the scope of this application.

Based on the foregoing, it will be appreciated that technologies for providing a physical harm deterrent system comprising a handheld video streaming device, a lighted alert, remote video streaming servers, and associated hardware and software are presented herein. The above-described embodiments are merely possible examples of implementations set forth for a clear understanding of the principles of the present disclosure. Many variations and modifications may be made to the above-described embodiments without departing substantially from the spirit and principles of the present disclosure. All such modifications and variations are intended to be included within the scope of the present disclosure, and all possible claims to individual aspects or combinations and sub-combinations of elements or steps are intended to be supported by the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or other computing system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A method comprising steps of:
receiving, by a handheld video streaming device, an initiation of a physical harm deterrent application by a user of the handheld video streaming device;
in response to receiving the initiation, activating, by the physical harm deterrent application, a video camera of the handheld video streaming device;
in conjunction with the activation of the video camera by the physical harm deterrent application, activating a lighted alert feature of the handheld video streaming device, the lighted alert feature configured to indicate to persons approaching the user of the handheld video streaming device the physical harm deterrent application is active; and
streaming, by the physical harm deterrent application, live video from the video camera to a remote storage location.

2. The method of claim 1, wherein the handheld video streaming device comprises a smartphone.

3. The method of claim 2, wherein the video camera comprises an embedded camera on a back surface of the smartphone.

4. The method of claim 2, wherein the lighted alert feature comprises one or more of a light and a visual lit-up emblem integrated into a cellphone case of the smartphone.

5. The method of claim 1, wherein the lighted alert feature comprises a flashing light.

6. The method of claim 1, further comprising the step of, in conjunction with activating the lighted alert feature, activating, by the physical harm deterrent application, an audio alert feature of the handheld video streaming device.

7. The method of claim 6, wherein activating the audio alert feature comprises playing an alert tone through a phone sound alarm system embedded in a smartphone.

8. The method of claim 1, further comprising steps of:
receiving, by a remote video streaming server located at the remote storage location, the streamed video from the a handheld video streaming device; and
storing the received video in a video storage, the received video associated in the video storage with the handheld video streaming device.

9. A non-transitory computer-readable medium containing processor-executable instructions that, when executed by a processor of a by a handheld video streaming device, cause the processor to:
in response to receiving an initiation of a physical harm deterrent application by a user of the handheld video streaming device, activate a video camera of the handheld video streaming device;
in conjunction with the activation of the video camera, activate a lighted alert feature of the handheld video streaming device, the lighted alert feature configured to indicate to persons approaching the user of the handheld video streaming device that the physical harm deterrent application is active; and
stream live video from the video camera to a remote storage location.

10. The non-transitory computer-readable medium of claim 9, wherein the handheld video streaming device comprises a smartphone.

11. The non-transitory computer-readable medium of claim 10, wherein the video camera comprises an embedded camera on a back surface of the smartphone.

12. The non-transitory computer-readable medium of claim 10, wherein the lighted alert feature comprises an embedded light on the smartphone.

13. The non-transitory computer-readable medium of claim 12, wherein activation of the lighted alert feature comprises the processor causing the embedded light to flash.

14. The non-transitory computer-readable medium of claim 9, comprising further processor-executable instructions that cause the processor to activate an audio alert feature of the handheld video streaming device.

15. The non-transitory computer-readable medium of claim 14, wherein activating the audio alert feature comprises playing an alert tone through a phone sound alarm system embedded in a smartphone.

16. A physical harm deterrent system comprising:
an app for execution on a smartphone, the app configured to, upon initiation by a user of the smartphone, activate a video camera of the smartphone and stream live video from the video camera to a remote storage location;
a lighted alert feature associated with the smartphone and configured to be activated in conjunction with the activation of the of the video camera by the app; and
at least one remote video streaming server located as the remote storage location, the remote video streaming server configured to receive the streamed video from the smartphone and store the received video in a video storage, the received video associated in the video storage with the smartphone.

17. The physical harm deterrent system of claim 16, wherein the video camera comprises an embedded camera on a back surface of the smartphone.

18. The physical harm deterrent system of claim 16, wherein the lighted alert feature comprises one or more of a light and a visual lit-up emblem integrated into a cellphone encasing the smartphone.

19. The physical harm deterrent system of claim 16, wherein the app is further configured to, in conjunction with activating the video camera, activate an audio alert feature comprising a phone sound alarm system embedded in a smartphone.

20. The physical harm deterrent system of claim 16, wherein the at least one remote video streaming server is further configured to, in response for a request for stored video associated with the smartphone received from a computing device, retrieve the stored video from the video storage and stream the retrieved video to the computing device for display on a display of the computing device.
